(19) United States
(12) Patent Application Publication
(10) Pub. No.: US 2020/0067153 A1
(43) Pub. Date: Feb. 27, 2020

(54) HEAT SHARING BETWEEN BATTERIES AND ELECTRONIC SYSTEMS

(71) Applicant: LOON LLC, Mountain View, CA (US)

(72) Inventor: Kevin Anderson, Mountain View, CA (US)

(73) Assignee: LOON LLC, Mountain View, CA (US)

(21) Appl. No.: 16/111,844

(22) Filed: Aug. 24, 2018

(51) Int. Cl. H01M 10/6551; H01M 10/615; H01M 10/657; H01M 10/42; H01M 2/10

(52) U.S. Cl. CPC H01M 10/6551; H01M 10/615; H01M 2/1016; H01M 10/4257; H01M 10/657

(57) ABSTRACT

A heat transfer system includes an electronic system dissipating heat and a battery pack electrically connected to the electronic system. The battery pack includes a battery housing and a battery cell module disposed within the battery housing. The battery housing surrounds the electronic system such that the heat dissipated by the electronic system is transferred to the battery pack.

### BACKGROUND

### Technical Field

The present disclosure relates to a heat transfer system and, more particularly, to a heat transfer system for use with electronic devices operable in a wide range of temperatures.

### Background

Electronic devices have long been used in industrial applications, and many techniques have been developed to accommodate the electronic devices in various operating environments. However, one of the important factors to consider in building an electronic device is the wide range of operating temperatures. For example, in an environment such as, e.g., the stratosphere, the electronic device must operate in a range of about 200 degrees Celsius. For example, the electronic device must operate in temperatures as low as −100 degrees Celsius, while still being operable in temperatures as high as 100 degrees Celsius.

As the electronic device is exposed to a wide range of extreme temperatures, it is crucial to provide adequate heat to the electronic device to ensure that the electronic device is within the range of operating temperatures, while dissipating excess heat to inhibit overheating of the electronic device in order to keep the electronic device sound and minimize damage to the electronic device. However, this is challenging because electronic devices in extreme range of operating temperatures often require mission-critical power budget targets.

Therefore, a continuing need exists for a heat transfer system that works with current electronic devices to overcome usability challenges associated with extreme range of operating temperatures without impairing the performance requirements.

### SUMMARY

The present disclosure describes a heat transfer system that demonstrates a practical approach to meeting the performance requirements and overcoming usability challenges associated with electronics devices in an extreme range of operating temperatures. In accordance with an embodiment of the present disclosure, a heat transfer system includes an electronic system dissipating heat and a battery pack electrically connected to the electronic system. The battery pack includes a battery housing and a battery cell module disposed within the battery housing. The electronic system is surrounded by the battery housing such that the heat generated by the operating of the electronic system is transferred to the battery pack and dissipated therewithin.

In an embodiment, the electronic system and the battery housing may define an air gap therebetween.

In another embodiment, the electronic system may include stacked printed circuit boards.

In yet another embodiment, the battery housing of the battery pack may include first and second support members configured to support the battery cell module therebetween.

In yet another embodiment, each of the first and second support member may define a bore dimensioned to receive a portion of the battery cell module to secure the battery cell module thereto.

In still yet another embodiment, the battery pack may further include a plurality of battery cell modules surrounding the electronic system.

In accordance with another embodiment of the present disclosure a heat transfer system includes an electronic system dissipating heat, a heating core thermally coupled with the electronic system, a separate heating core thermally coupled with the battery cells, and a battery pack including a battery housing and a battery cell module disposed within the battery housing. The heating core is surrounded by the battery housing such that the heat dissipated by the electronic system is transferred to the battery pack.

In an embodiment, the electronic system may be remotely disposed from the battery pack.

In another embodiment, the battery housing may be formed of heat resistant material.

In yet another embodiment, the battery housing may be formed of at least one of metal or phenolic resin.

In still yet another embodiment, the battery pack may have operating temperatures in a range of about 0 degree Celsius and about 50 degrees Celsius.

In an embodiment, the battery pack may further include a thermal contact member thermally coupled to the heating core.

In another embodiment, the thermal contact member may extend from the battery cell module to the heating core through the battery housing.

In yet another embodiment, the thermal contact member may be formed of at least one of a metal or a polymer.

In yet another embodiment, the thermal contact member may be formed of a material that provides a lower resistance conductive path for heat compared to the battery housing.

In still yet another embodiment, the thermal contact member may be formed of a material that provides a lower resistance conductive path for heat compared to an air gap defined between the battery cell module and the battery housing.

In an embodiment, the battery housing may include an outer surface including a thermally insulating layer configured to retain heat within the battery housing.

In another embodiment, the battery housing may further include a thermally conductive portion outwardly extending through the outer surface of the battery housing to dissipate heat therethrough in order to inhibit overheating of the battery pack.

In an embodiment, the electronic system may have lower heat capacity than heat capacity of the battery pack.

In another embodiment, the battery cell module may include an electrochemical storage cell.

In yet another embodiment, the heat transfer system may further include a heater providing heat to the battery pack.

In still yet another embodiment, the electronic system may include a printed circuit board.

### DESCRIPTION OF THE DRAWINGS

The foregoing objects, features and advantages of the disclosure will become more apparent from a reading of the following description in connection with the accompanying drawings, in which:

FIG. 1 is a perspective view of a heat transfer system in accordance with an embodiment of the present disclosure;

FIG. 2 is an exploded perspective view of the heat transfer system of FIG. 1 with parts separated;

FIG. 3 is a schematic view of a heat transfer system in accordance with another embodiment of the present disclosure;

FIG. 4 is a schematic view of a heat transfer system in accordance with another embodiment of the present disclosure; and

FIG. 5 is a schematic view of a heat transfer system in accordance with another embodiment of the present disclosure.

### DETAILED DESCRIPTION

Embodiments of the present heat transfer system will now be described in detail with reference to the drawings, in which like reference numerals designate identical or corresponding elements in each of the several views. In the following description, well-known functions or constructions are not described in detail to avoid obscuring the present disclosure in unnecessary detail.

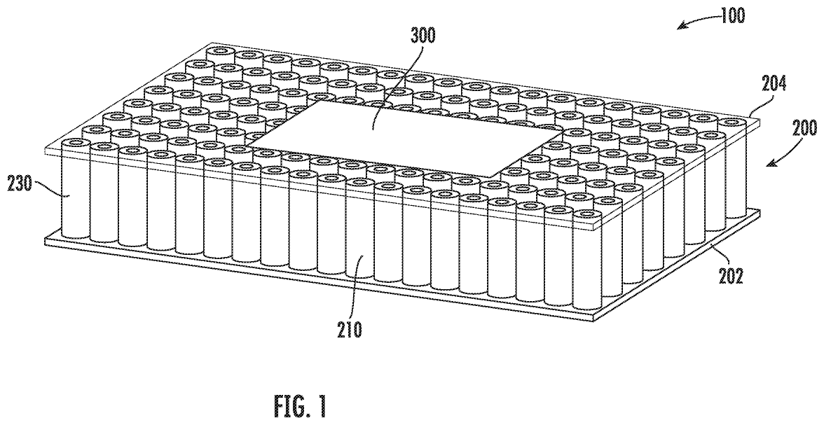

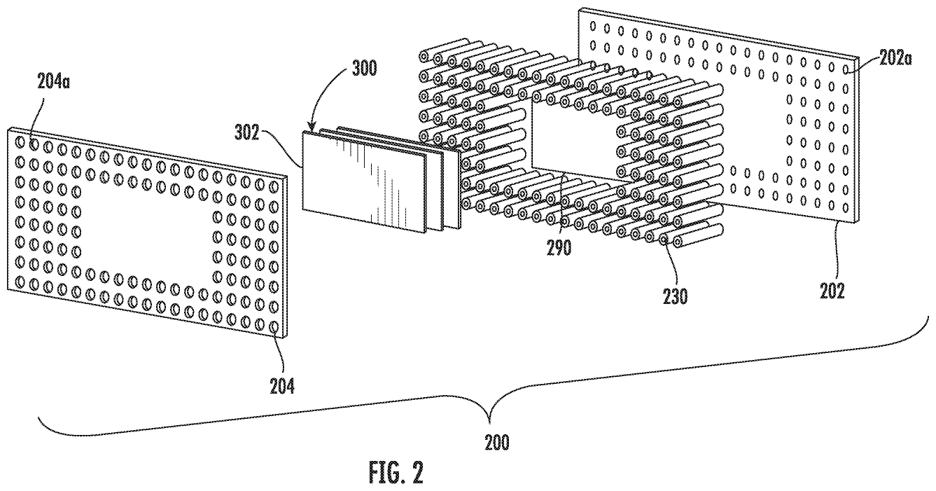

With reference to FIGS. 1 and 2, an embodiment of the present disclosure is generally shown as a heat transfer system 100. The heat transfer system 100 is particularly adapted for use with electronic devices operating in a wide range of temperatures. The heat transfer system 100 may buffer and dissipate heat, which may be critical to a variable-power system that requires mission-critical power budget targets. The heat transfer system 100 includes a battery pack 200 and an electronic system 300. The electronic system 300 may include a plurality of printed circuit boards 302 in superposed relation. The plurality of printed circuit boards 302 may be stacked to consolidate all central processing capabilities and heat dissipation. Basic components of the printed circuit boards 302 will not be described herein, as the internal construction of the printed circuit boards 302 is well known in the art. The electronic system 300 such as, e.g., avionics, generates heat that needs to be evacuated. The electronic system 300 generally has low heat capacity. Thus, the heat generated by the electronic system 300 needs to be safely dissipated or removed in order to inhibit possible burnout of components of the electronic system 300.

The battery pack 200 has high heat capacity. However, when operating in low temperatures, a heater (not shown) may be utilized to provide necessary heat to the battery pack 200 in order to maintain operability thereof. For example, the temperature of the battery pack 200 needs to be above freezing, i.e., 0 degree Celsius. The heat transfer system 100 utilizes the heat generated by the electronic system 300 to provide “survival heat” to the battery pack 200. Under such a configuration, the heater which consumes power in a system that requires mission-critical power budget targets, may consume less power.

To this end, the battery pack 200 may be effectively positioned relative to the electronic system 300 requiring removal of the heat. In particular, the plurality of printed circuit boards 302 may be stacked to consolidate all central processing capabilities and heat dissipation within the battery pack 200. In particular, the battery pack 200 forms a wall or a barrier 210 enclosing the electronic system 300 in order to capture the heat dissipated by the electronic system 300. In this manner, the heater (not shown) utilized to maintain the operating temperature of the battery pack 200 may have a lower heating load, thereby resulting in a more efficient system.

The battery pack 200 includes a plurality of battery cell modules 230 and first and second support members 202, 204. Each of the first and second support members 202, 204 includes structures such as, e.g., bores 202a, 204a, configured to securely support the plurality of battery cell modules 230 therebetween. The first and second support members 202, 204 may be formed from various materials or combinations of materials. For example, the first and second support members 202, 204 may be formed of a rigid material, such as, e.g., metal or a polymer. Furthermore, the battery pack 200 may be formed of a heat resistant material such as, e.g., aluminum or phenolic resin or another engineering grade polymer. Specifically, the heat resistant material may be capable of withstanding temperatures of at least 60-80 degrees Celsius without significantly degrading (e.g., melting or becoming soft).

The plurality of battery cell modules 230 are arranged with the first and second support members 202, 204 such that the battery pack 200 defines the internal volume 290 dimensioned to receive the electronic system 300 therein. In particular, the heat transfer system 100 may define a gap between the electronic system 300 and the plurality of battery cell modules 230 surrounding the electronic system 300 when the electronic system 300 is disposed within the internal volume 290. Alternatively, the electronic system 300 may be in direct contact with the plurality of battery cell modules 230 surrounding the electronic system 300 when the electronic system 300 is disposed within the internal volume 290.

The battery pack 200 may be any structure that defines the internal volume 290 having a sufficient size and shape to receive the electronic system 300. Therefore, the overall dimensions of the battery pack 200 may be dictated by the dimensions of the electronic system 300, as well as the dimensions and the total number of battery cell modules 230 disposed in the battery pack 200.

The battery cell module 230 may be an electrochemical storage cell. The battery pack 200 may include a pair of electrodes (not shown) extending from a battery cell module 230 to an outer surface of one of the first and second support members 202, 204 to transfer an electric charge to/from the battery cell module 230.

Each battery cell module 230 may include one or more electrochemical cells or, more typically, two or more electrochemical cells. For example, the battery cell modules 230 may include lithium-ion cells. The battery cell modules 230 may be electrically interconnected, such as in series, to achieve the target voltage of the battery pack 200. The number of battery cell modules 230 in the battery pack 200 may depend on the module voltages of the battery cell modules 230 and the target voltage of the battery pack 200. Optionally, the heat transfer system 100 may be placed in, e.g., a shrink tubing, in order to enhance securement of the battery pack 200 and the electronic system 300 together.

With reference now to FIG. 3, there is illustrated a heat transfer system 500 in accordance with another embodiment of the present disclosure. Portions of the heat transfer system 500 substantially identical to the heat transfer system 100 are not described in detail to avoid obscuring the present disclosure in unnecessary detail. The heat transfer system 500 includes the electronic system 300, a heating core 350 thermally coupled with the electronic system 300, and the battery pack 600 that needs necessary heat in low temperatures to maintain operability thereof. A heater 800 may optionally be provided to supply heat to the battery pack 600 when the battery pack 600 is in the low temperatures.

As discussed hereinabove, the battery pack 600 may capture the heat dissipated by the electronic system 300 in order to maintain the operability of the battery pack 600 in low temperatures. In particular, the heating core 350 thermally coupled with the electronic system 300 is utilized to transfer the heat generated by the electronic system 300 to the battery pack 600. In particular, the battery pack 600 forms a barrier 610 defining an internal volume 690 and surrounding the heating core 350. In this manner, the electronic system 300 may be remotely disposed away from the battery pack 600 such that the heat transfer system 500 may be tailored to the configuration of a particular system. In this manner, the heater 800 utilized to maintain the operating temperature of the battery pack 600 may have a lower heating load, thereby resulting in a more efficient system. While the heat transfer system 500 illustrates an air gap defined between the heating core 350 and the barrier 610 of the battery pack 600, it is also envisioned that the heating core 350 may be in contact with the barrier 610 of the battery pack 600.

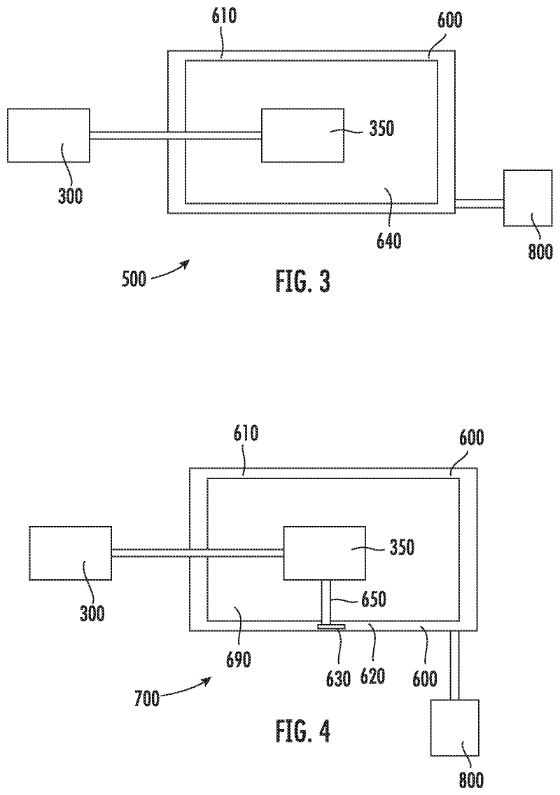

With reference now to FIG. 4, a heat transfer system in accordance with another embodiment of the present disclosure is shown as a heat transfer system 700. Portions of the heat transfer system 700 substantially identical to the heat transfer systems 100, 500 are not described in detail to avoid obscuring the present disclosure in unnecessary detail. The heat transfer system 700 includes the electronic system 300, the heating core 350 thermally coupled with the electronic system 300, and the battery pack 600 that needs heat in low temperatures to maintain operability thereof. The battery pack 600 may capture the heat dissipated by the electronic system 300 in order to maintain operability thereof in low temperatures. To this end, the heating core 350 thermally coupled with the electronic system 300 is disposed within the internal volume 690 defined by the battery housing 620 and transfers the heat generated by the electronic system 300 to the battery pack 600. As discussed hereinabove, the battery pack 600 forms the barrier 610 around the heating core 350 thermally coupled with the electronic system 300. In addition, the battery pack 600 further includes a thermal contact member 650 thermally coupling the heating core 350 and a battery cell module 630 of the battery pack 600. In particular, the thermal contact member 650 extends from the battery cell module 630 to the heating core 350 through the battery housing 620 and conducts heat from the heating core 350 to the battery cell module 630.

The thermal contact member 650 may be formed of a material such as, e.g., a metal or a polymer. The thermal contact member 650 provides a pathway for heat to transfer away from the heating core 350 and ultimately from the electronic system 300 because the thermal contact member 650 provides a lower resistance conductive path for the heat in comparison to the battery housing 620 and the air gap between the battery cell module 630 and the battery housing 620. It is contemplated that a plurality of thermal contact members 650 may be arranged about the heating core 350 in a manner most suitable for a particular system. In this manner, the heater 800 utilized to provide heat to the battery pack 600 in low temperatures may have a lower heating load, thereby resulting in a more efficient system.

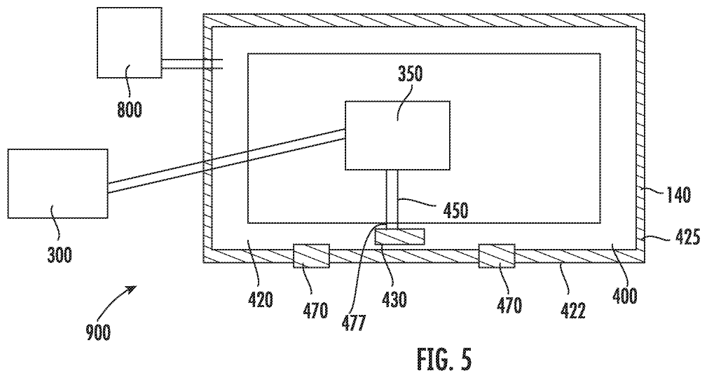

With reference now to FIG. 5, a heat transfer system 900 in accordance with another embodiment of the present disclosure is illustrated. Portions of the heat transfer system 900 substantially identical to the heat transfer systems 100, 500, 700 are not described in detail to avoid obscuring the present disclosure in unnecessary detail. The heat transfer system 900 includes the electronic system 300, the heating core 350 thermally coupled with the electronic system 300, and a battery pack 400 that requires heat in low temperatures to maintain operability thereof. The battery pack 400 is configured to capture the heat dissipated by the electronic system 300 in order to maintain the temperature of the battery pack 400 within the operating temperatures. To this end, the heating core 350 thermally coupled with the electronic system 300 is utilized to transfer the heat generated by the electronic system 300 to the battery pack 400. In particular, the battery pack 400 forms a wall or a barrier 410 surrounding the heating core 350 thermally coupled with the electronic system 300. In addition, the battery pack 400 further includes a thermal contact member 450 thermally coupled to the heating core 350. The thermal contact member 450 may be formed a material such as, e.g., a metal or a polymer. In particular, the thermal contact member 450 extends from a battery cell module 430 of the battery pack 400 to the heating core 350 through the battery housing 420. The thermal contact member 450 conducts heat from the heating core 350 to the battery cell module 430. In this manner, the thermal contact member 450 provides a pathway for heat to transfer away from the heating core 350 and ultimately away from the electronic system 300 because the thermal contact member 450 provides a lower resistance conductive path for the heat in comparison to the battery housing 420 and the air gap 477 between the battery cell module 430 and the battery housing 420.

In addition, the battery housing 420 includes an outer surface 422 having an insulation layer 425 to retain the heat within the battery housing 420. However, the battery housing 420 may further include thermally conductive portions 470 arranged through the outer surface 422 to dissipate heat out of the battery housing 420 in order to inhibit overheating of the battery pack 400. It is contemplated that the number and placement of the thermally conductive portions 470 may be tailored to the particular system. As discussed hereinabove, it is also contemplated that a plurality of thermal contact members 450 may be arranged about the heating core 350 and/or the battery cell module 430 in a manner most suitable for the particular system. In this manner, the heater 800 utilized to maintain the operating temperature of the battery pack 400 may have a lower heating load, thereby resulting in a more efficient system.

The heat transfer systems 100, 500, 700, 900 enable devices such as the battery pack 200, 400, 600 to tolerate much wider operational swings such that the battery packs 200, 400, 600 may operate without overheating or freezing in extreme temperature environment such as in, e.g., stratospheric conditions. Under such a configuration, both heat generation and heat dissipation are effected by a single unified thermal solution to keep the battery packs 200, 400, 600 warm enough during, e.g., cold nights in the stratosphere, while also meeting the heat dissipation requirements of the electronic system 300 that gets hot during operation. The heat transfer systems 100, 500, 700, 900 are particularly beneficial in a system that operate in extreme range of temperatures that often requires mission-critical power budget targets

Persons skilled in the art will understand that the structures and methods specifically described herein and shown in the accompanying figures are non-limiting exemplary embodiments, and that the description, disclosure, and figures should be construed merely as exemplary of particular embodiments. For example, the battery housing 620 (FIG. 4) is shown to surround the electronic system 300 or the heating core 350. However, the battery housing 620 may partially surround the electronic system 300 or the heating core 350. In addition, while the thermal contact members 450, 650 are shown in the heat transfer system 700, 900, it is also contemplated that the thermal contact members 450, 650 may be utilized in the heat transfer systems 100, 500. It is to be understood, therefore, that the present disclosure is not limited to the precise embodiments described, and that various other changes and modifications may be effected by one skilled in the art without departing from the scope or spirit of the disclosure.

Additionally, the elements and features shown or described in connection with certain embodiments may be combined with the elements and features of certain other embodiments without departing from the scope of the present disclosure, and that such modifications and variations are also included within the scope of the present disclosure. Accordingly, the subject matter of the present disclosure is not limited by what has been particularly shown and described.

What is claimed is:

1. A heat transfer system comprising:
an electronic system dissipating heat; and
a battery pack electrically connected to the electronic system, the battery pack including a battery housing and a battery cell module disposed within the battery housing, the battery housing surrounding the electronic system such that the heat dissipated by the electronic system is absorbed by the battery pack.

2. The heat transfer system according to claim 1, wherein the battery housing is formed of heat resistant material.

3. The heat transfer system according to claim 1, wherein the battery pack has operating temperatures in a range of about 0 degree Celsius and about 50 degrees Celsius.

4. The heat transfer system according to claim 1, wherein the electronic system and the battery housing define an air gap therebetween.

5. The heat transfer system according to claim 1, wherein the electronic system includes stacked printed circuit boards.

6. The heat transfer system according to claim 1, wherein the battery housing of the battery pack includes first and second support members configured to support the battery cell module therebetween.

7. The heat transfer system according to claim 6, wherein each of the first and second support members defines a bore dimensioned to receive a portion of the battery cell module to secure the battery cell module thereto.

8. The heat transfer system according to claim 1, wherein the battery pack further includes a plurality of battery cell modules surrounding the electronic system.

9. A heat transfer system comprising:
an electronic system dissipating heat;
a heating core thermally coupled with the electronic system; and
a battery pack including a battery housing and a battery cell module disposed within the battery housing, the battery housing surrounding the heating core such that the heat dissipated by the electronic system is absorbed by the battery pack.

10. The heat transfer system according to claim 9, wherein the electronic system is remotely disposed from the battery pack.

11. The heat transfer system according to claim 9, wherein the battery housing is formed of heat resistant material.

12. The heat transfer system according to claim 11, wherein the battery housing is formed of at least one of metal or phenolic resin.

13. The heat transfer system according to claim 9, wherein the battery pack has operating temperatures in a range of about 0 degree Celsius and about 50 degrees Celsius.

14. The heat transfer system according to claim 9, wherein the battery pack further includes a thermal contact member thermally coupled to the heating core.

15. The heat transfer system according to claim 14, wherein the thermal contact member extends from the battery cell module to the heating core through the battery housing.

16. The heat transfer system according to claim 15, wherein the thermal contact member is formed of at least one of a metal or a polymer.

17. The heat transfer system according to claim 14, wherein the thermal contact member is formed of a material that provides a lower resistance conductive path for heat compared to the battery housing.

18. The heat transfer system according to claim 14, wherein the thermal contact member is formed of a material that provides a lower resistance conductive path for heat compared to an air gap defined between the battery cell module and the battery housing.

19. The heat transfer system according to claim 9, wherein the battery housing includes an outer surface including a thermally insulating layer configured to retain heat within the battery housing.

20. The heat transfer system according to claim 19, wherein the battery housing further includes a thermally conductive portion outwardly extending through the outer surface of the battery housing to dissipate heat therethrough in order to inhibit overheating of the battery pack.

21. The heat transfer system according to claim 14, wherein the electronic system has lower heat capacity than heat capacity of the battery pack.

22. The heat transfer system according to claim 9, wherein the battery cell module includes an electrochemical storage cell.

23. The heat transfer system according to claim 9, further comprising a heater providing heat to the battery pack.

24. The heat transfer system according to claim 9, wherein the electronic system includes a printed circuit board.
